(19) United States
(12) Patent Application Publication
(10) Pub. No.: US 2026/0214160 A1
(43) Pub. Date: Jul. 23, 2026

(54) ADAPTIVE LINE KEY ALLOCATION FOR KEY EXPANSION MODULES

(71) Applicant: Cisco Technology, Inc., San Jose, CA (US)

(72) Inventors: Huiguang HUANG, Minhang (CN); Zhimin JIN, Pudong District (CN); Zhao ZHE, Pudong District (CN); Hong QIU, Shanghai (CN); Dennis WU, Shanghai (CN)

(21) Appl. No.: 19/035,041

(22) Filed: Jan. 23, 2025

(51) Int. Cl. H04M 1/72466; G06F 3/0483; G06F 3/04886; H04M 1/02

(52) U.S. Cl. CPC H04M 1/72466; G06F 3/0483; G06F 3/04886; H04M 1/0254

(57) ABSTRACT

In one embodiment, a method for adaptive line key allocation for key expansion modules includes storing, by a process, a list of line keys for a phone that has a line key display and determining, by the process, a first set of line keys from the list of line keys to display on the phone when a key expansion module is paired to the phone and a second set of the line keys to display on the key expansion module. The method further includes determining whether the key expansion module is paired to the phone, displaying the first set of the line keys on the phone when the key expansion module is paired to the phone, and displaying the second set of the line keys on the key expansion module when the key expansion module is paired to the phone.

### TECHNICAL FIELD

The present disclosure relates generally to computer networks, and, more particularly, to adaptive line key allocation for key expansion modules.

### BACKGROUND

In general, a telecommunication device, such as a landline telephone, voice over internet protocol (VoIP) phone, smartphone, phablet, etc. displays a limited number of line keys and feature keys on its home page or home screen. On such telecommunication devices, when the configured line key and/or feature key count exceeds the line key and/or feature key count that the home page can accommodate, more pages (e.g., pages to display additional line keys and/or feature keys) may be added to the device. In general, with the exception of the home page, these additional pages are hidden. As a result, in order to access these additional pages, a user must switch from the home page to one of the additional (hidden) pages by some method. This can be inconvenient for the user to access these additional pages and hence the additional line keys and/or feature keys displayed on such additional pages.

In an effort to resolve these frustrations, a key expansion module (KEM) may be coupled to the telecommunication device to provide access to additional line keys and/or feature keys that may be used in connection with operation of the telecommunication device. In general, the line keys and/or feature keys displayed on the KEM can include line keys and/or feature keys that are configured for the KEM itself. As a result, even though a KEM is attached to the telecommunication device, the hidden line keys and feature keys configured for the telecommunication device may still be retained on the hidden pages of the telecommunications device. Unfortunately, it can still be inconvenient for the user to access the additional pages and hence the additional line keys and/or feature keys displayed on such additional pages on the telecommunication device even when a KEM is coupled to the telecommunication device.

Further, the line keys and feature keys of a telecommunication device are generally fixed. That is; in order to make hidden line key and/or hidden feature keys visible to a user, an administrator may be required to move the hidden line keys or feature key from the screen of the telecommunication device to the KEM. This process can include deletion (by the administrator) of line keys and/or feature keys from the screen of the telecommunication device, followed by manual addition of these line keys and/or feature keys to the KEM. Only after these key layout changes are made by the administrator, can the line keys and/or feature keys be seen on the KEM. These processes can be tedious and inconvenient for the administrator, leading to additional costs and delays in setting up systems that include telecommunication devices and KEMs.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of line keys and/or feature keys displayed on home page of a phone and some line keys and/or feature keys displayed on hidden pages of the phone;

FIG. 4 illustrates an example of line keys and/or feature keys displayed on home page of a phone and some line keys and/or feature keys displayed on hidden pages of the phone while the phone is paired with a key extension module;

FIGS. 5A-5B illustrate two examples of backend line key/function key configuration lists;

FIG. 6 illustrates an example of a phone paired to a key extension module subsequent to manual configuration of the phone and/or key extension module by an administrator;

FIG. 7 illustrates an example of a phone paired to a key extension module where the key extension module where a specified number of keys are automatically moved to the key extension module in response to pairing the key extension module to the phone;

FIG. 8 illustrates an example of key pages associated with a phone when the phone is not paired to a key extension module;

FIG. 9 illustrates an example of a phone paired to a key extension module where the key extension module where a specified number of keys are automatically moved to the key extension module in response to pairing the key extension module to the phone; and

FIG. 10 illustrates an example procedure for adaptive line key allocation for key expansion modules.

### DESCRIPTION OF EXAMPLE EMBODIMENTS

### Overview

According to one or more embodiments of the disclosure, a method includes storing, by a process, a list of line keys for a phone that has a line key display and determining, by the process, a first set of line keys from the list of line keys to display on the phone when a key expansion module is paired to the phone and a second set of the line keys to display on the key expansion module. The method further includes determining whether the key expansion module is paired to the phone, displaying the first set of the line keys on the phone when the key expansion module is paired to the phone, and displaying the second set of the line keys on the key expansion module when the key expansion module is paired to the phone.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

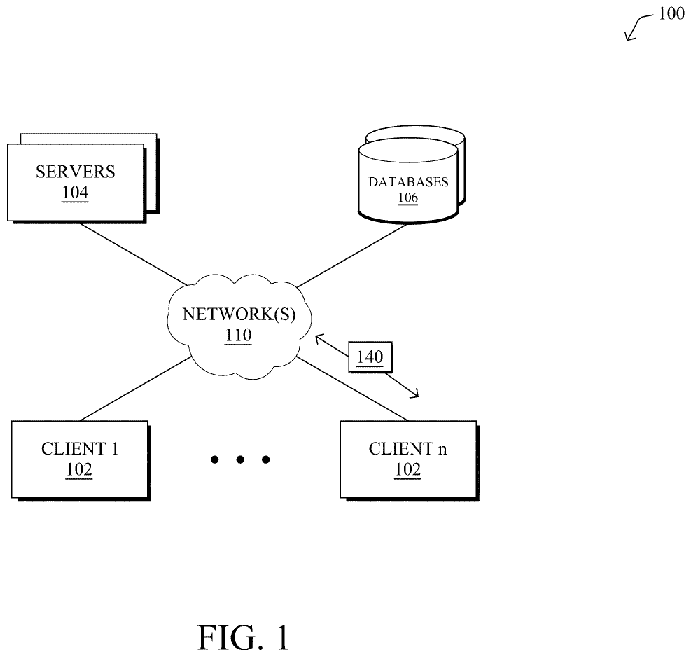

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, desktop phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

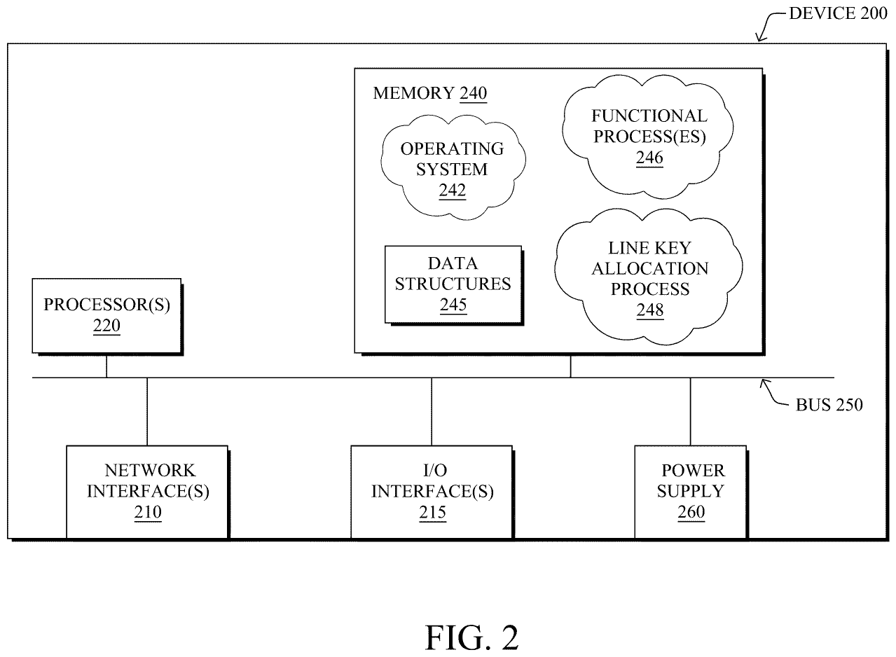

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242, portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a line key allocation process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a phone would be configured to operate as a phone, a server would be configured to operate as a server, a client device would be configured to operate as a client device, and so on.

In various implementations, as detailed further below, one or more functional processes 246 and/or line key allocation processes (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Adaptive Line Key Allocation for Key Expansion Modules

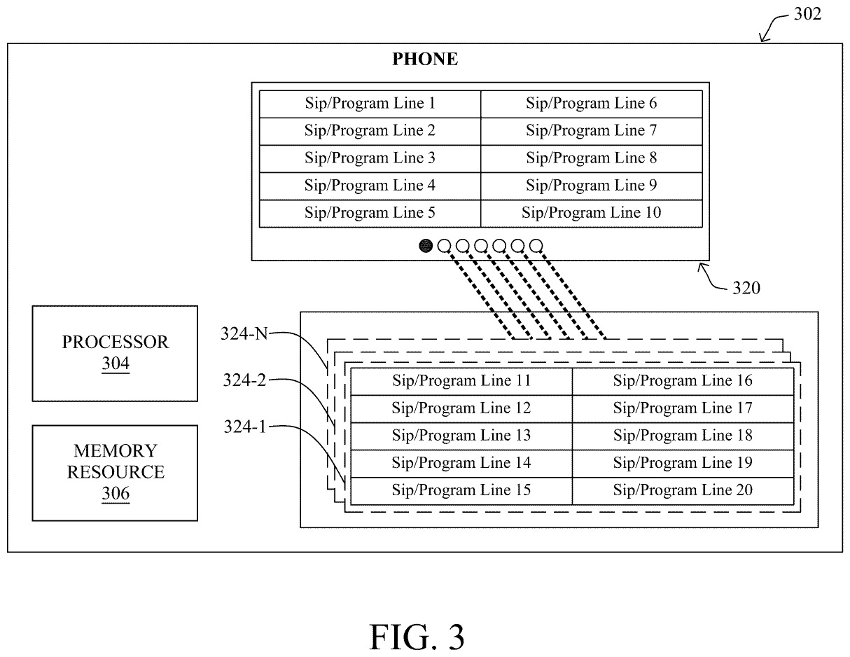

FIG. 3 illustrates an example of line keys and/or feature keys displayed on home page of a phone and some line keys and/or feature keys displayed on hidden pages of the phone. Throughout the disclosure the term “phone” may be substituted for “telecommunication device” in the interest of brevity and simplicity. It will be appreciated that, when the term “phone” is used, the term is meant to encompass any type of telecommunication device including, but not limited to landline phones, VoIP phones, mobile phones, smartphones, phablets, and/or tablets, and so on and so forth.

As shown in FIG. 3, a phone 302 includes a processor 304 and a memory resource 306. The processor 304 can be configured to execute instructions stored in the memory resource 306 to perform the operations discussed herein. In addition, the memory resource 306 can be configured to store various information, such as information corresponding to line keys, function keys, phone numbers, etc. associated with the phone 302. Although shown as being included in the phone 302, the memory resource 306 can, in the alternative, be a separate memory resource (e.g., cloud memory, etc.) that is communicatively coupled to the processor 304 and/or the phone 302.

The phone 302 further includes a home page 320 (displayed on a screen) and a plurality of hidden pages (e.g., a first hidden page 324-1, a second hidden page 324-2, through an N^{th} hidden page 324-N), which may also be displayed on the screen. As shown in FIG. 3, the home page 320 displays a plurality of line keys and/or function keys (Sip/Program Line 1 through Sip/Program Line 10) and the first hidden page 324-1 displays a plurality of line keys and/or function keys (Sip/Program Line 11 through Sip/Program Line 20). Although not explicitly shown in FIG. 3, it will be appreciated that the other hidden pages may display various line keys and/or function keys as well.

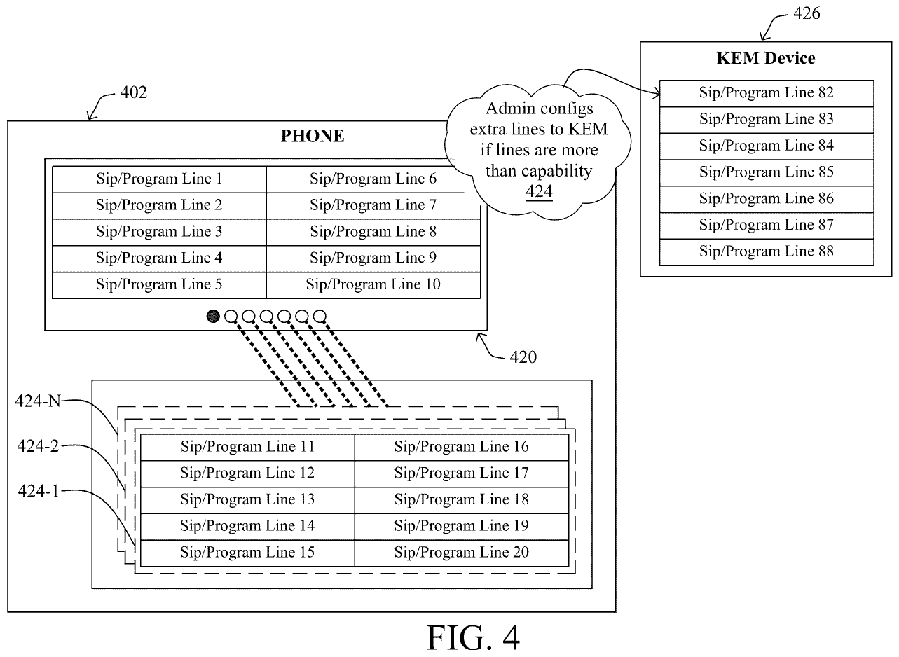

FIG. 4 illustrates an example of line keys and/or feature keys displayed on home page of a phone and some line keys and/or feature keys displayed on hidden pages of the phone while the phone is paired with a key extension module. The phone 402 can be analogous to the phone 302 illustrated in FIG. 3. Similarly, the home page 420 and a plurality of hidden pages (e.g., a first hidden page 424-1, a second hidden page 424-2, through an N^{th} hidden page 424-N) can be analogous to the home page 320 and plurality of hidden pages (e.g., a first hidden page 324-1, a second hidden page 324-2, through an N^{th} hidden page 324-N) of FIG. 3.

As shown in FIG. 4, a key extender module (KEM 426) is paired (e.g., communicatively coupled) to the phone 402. It is noted that the line keys and/or functions keys of the KEM 426 are configured for the KEM 426 itself. That is, even though the KEM 426 is paired to the phone 402, the hidden line keys and feature keys configured for the phone 402 will still be retained on the hidden pages on the phone 402. That is, the plurality of line keys and/or function keys (Sip/Program Line 11 through Sip/Program Line 20) in the hidden pages of the phone remain unchanged while a plurality of line keys and/or function keys (Sip/Program Line 82 through Sip/Program Line 87) of the KEM 426 are configured for the KEM 426 itself.

Further, it is noted that, as shown in FIG. 4, the line keys and feature keys on the phone screen are fixed. To make the line keys and/or functions keys on the KEM 426 visible, an administrator needs to configure extra lines to the KEM 426, as shown at operation 424. In addition, in some approaches, the administrator may also need to manually move the hidden line keys or feature key from the phone screen(s) to the KEM 426 and/or the administrator may need to delete the line keys or feature keys from the phone screen(s) and then add the line keys or feature keys to the KEM 426, as shown in FIGA. 5A-5B. These processes can be inconvenient and time consuming for the administrator.

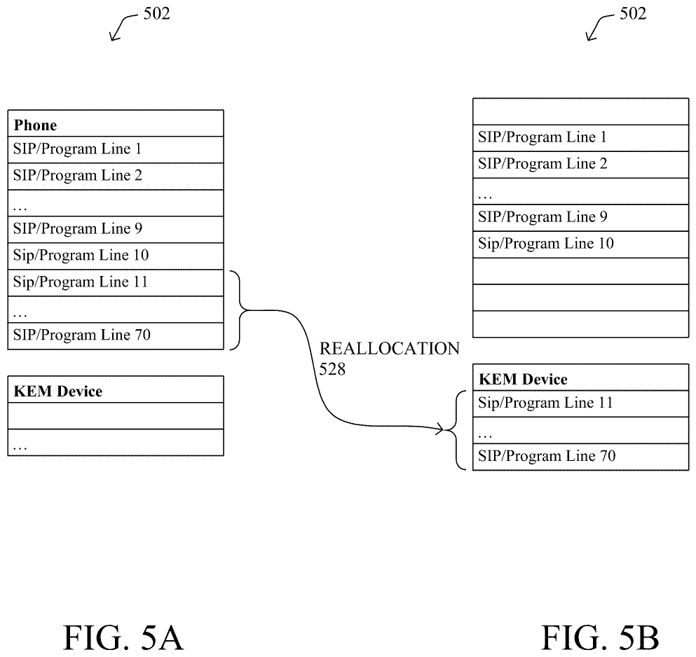

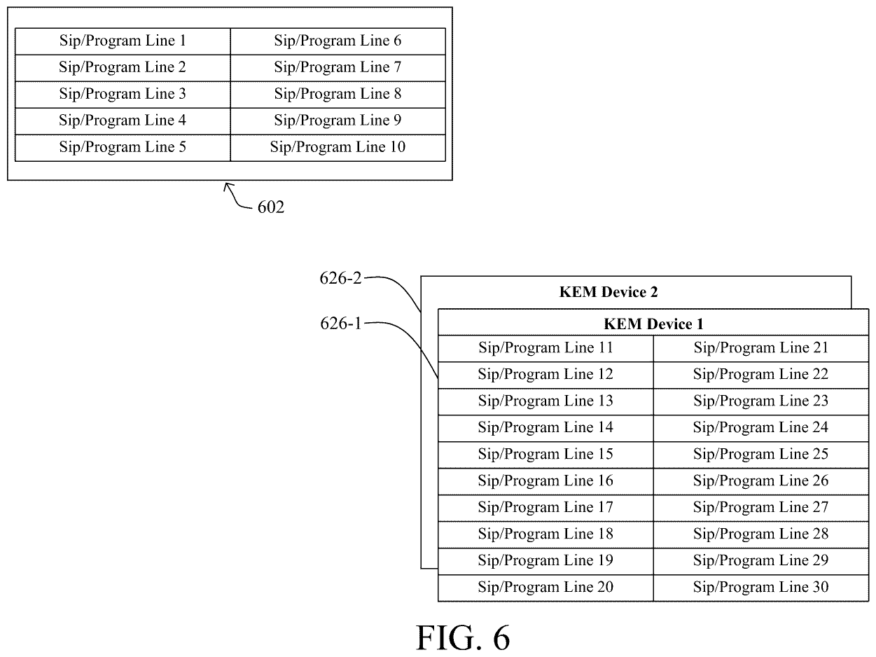

FIGS. 5A-5B illustrate two examples of backend line key/function key configuration lists. FIG. 5A shows a backend line key/function key configuration list 502 with line keys/function keys for a phone and no line keys/function keys for KEM(s). The line keys/function keys in FIG. 5A map to the line keys/function keys in FIG. 3 and/or the line keys/function keys in FIG. 4. FIG. 5B shows a backend line key/function key configuration list 502 subsequent to reallocation 528. An example final result of performance of these operations by the administrator is shown below in FIG. 6.

FIG. 6 illustrates an example of a phone paired to a key extension module subsequent to manual configuration of the phone and/or key extension module by an administrator. The phone 602 can be analogous to the phone 302 illustrated in FIG. 3 and/or the phone 402 of FIG. 4, while the KEM (e.g., the first page of the KEM 626-1 and/or the second page of the KEM 626-2) can be analogous to the KEM 426 of FIG. 4.

As shown in FIG. 6, after the administrator has performed the laborious and inconvenient process of manually configuring extra lines to the KEM, a plurality of line keys and/or function keys (Sip/Program Line 11 through Sip/Program Line 30) previously associated with hidden pages of the phone 602 can be displayed on the first page of the KEM 626-1, while additional line keys and/or function keys can be displayed on the second page of the KEM 626-2.

As noted above, the inconveniences associated with accessing line keys and/or function keys on hidden pages of a phone and/or the time-intensive and inconvenient processes that administrators may suffer in configuring a key extension module (KEM) to show line keys and/or function keys on hidden pages of the phone can lead to wasted resources, as well as frustration to both users and administrators of systems that employ phones and/or KEMs.

The techniques herein, therefore, describe a system designed to enhance the visibility and accessibility of line keys and/or feature keys across both a phone screen and KEMs paired to the phone. As discussed in more detail, herein, the systems of the present disclosure can also reduce the workload of the administrator tasked with managing the phones, thereby saving valuable resources, as well as mitigating frustration to both the administrator and the users of such systems.

Specifically, according to one or more embodiments of the disclosure as described in detail below, a method for adaptive line key allocation for key expansion modules includes storing, by a process, a list of line keys for a phone that has a line key display and determining, by the process, a first set of line keys from the list of line keys to display on the phone when a key expansion module is paired to the phone and a second set of the line keys to display on the key expansion module. The method further includes determining whether the key expansion module is paired to the phone, displaying the first set of the line keys on the phone when the key expansion module is paired to the phone, and displaying the second set of the line keys on the key expansion module when the key expansion module is paired to the phone.

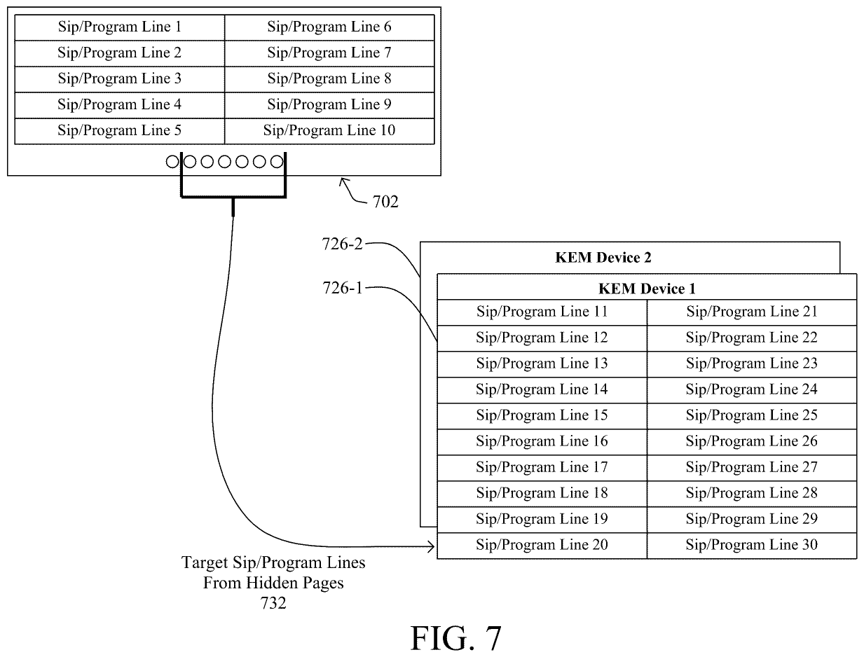

Operationally, FIG. 7 illustrates an example of a phone paired to a key extension module where the key extension module where a specified number of keys are automatically moved to the key extension module in response to pairing the key extension module to the phone. The phone 702 can be analogous to the phone 302 illustrated in FIG. 3, the phone 402 of FIG. 4, and/or the phone 602 of FIG. 6, while the KEM (e.g., the first page of the KEM 726-1 and/or the second page of the KEM 726-2) can be analogous to the KEM 426 of FIG. 4, and/or the KEM of FIG. 6. However, as will be described in more detail below, the phone and/or the KEM shown in FIG. 7 include additional features and/or capabilities that enhance the visibility and accessibility of line keys and/or feature keys across both a phone screen and KEMs paired to the phone as compared to previous approaches. In addition, the phone and/or the KEM shown in FIG. 7 can reduce the workload of the administrator tasked with managing the phones, thereby saving valuable resources, as well as mitigating frustration to both the administrator and the users of such systems.

As mentioned above, before KEM(s) are attached to a phone, the phone lists all the configured lines (e.g., line keys, function keys, etc.). However, due to the limited space of the phone screen, some line keys and feature keys are listed in the hidden pages. To access the line keys or feature keys on the hidden pages, the user must switch to a hidden page by some method as discussed above in connection with FIG. 3.

In some approaches, when a KEM is attached to the phone, only a specified number of the first keys are kept on the phone screen. The specified number is generally determined by a parameter (e.g., the amount of space on the screen pf the phone, a quantity of physical buttons on the phone, a pre-installed limit on the number of visible keys, etc.). Further, the phone generally shows only the home page, while other line keys and/or feature keys may be moved to hidden pages.

However, in contrast to previous approaches, implementations herein allow for the other line keys and feature keys (e.g., line keys and/or feature keys that may typically be relegated to hidden pages) to be moved to the KEM automatically. That is, in contrast to some approaches that require cumbersome and time-consuming administrator intervention to configure the KEM, implementations herein allow for additional line keys and/or feature keys that are not displayed on the home screen of the phone to automatically moved to the KEM. In some implementations, this automatic configuration of the KEM can be done in response to the KEM being paired (either via a physical “plug in” connection or via a wireless connection) to the phone.

Further, implementations described herein allow for this automatic configuration of line keys and/or feature keys to the KEM in the absence of changes being made to the line layout, as shown in FIG. 4. Moreover, by moving the line keys and/or feature keys from the phone side (e.g., from hidden pages associated with the phone) to the key expansion module, all the line keys and/or feature keys are visible and easy to access from a user perspective. For example, as shown in FIG. 7, where the specified key count on phone is ten, only ten line keys or feature keys are kept on the phone screen while the other line keys and feature keys are moved to the KEM(s) automatically, as shown at operation 732.

In addition, in accordance with the disclosure, when the connected KEM(s) are detached from the phone, the line keys and feature keys shown on the KEM(s) will be moved back to the phone. Again, this process is done automatically. That is, no user interaction or administrator interaction is required to transfer line keys and/or function keys displayed on the KEM(s) back to the phone when the KEM(s) is disconnected from the phone. Further, no line layout change is required subsequent to disconnection of the KEM(s) from the phone and therefore the user still has all the configured line keys and feature keys on the phone that the user had access to prior to connecting the KEM(s).

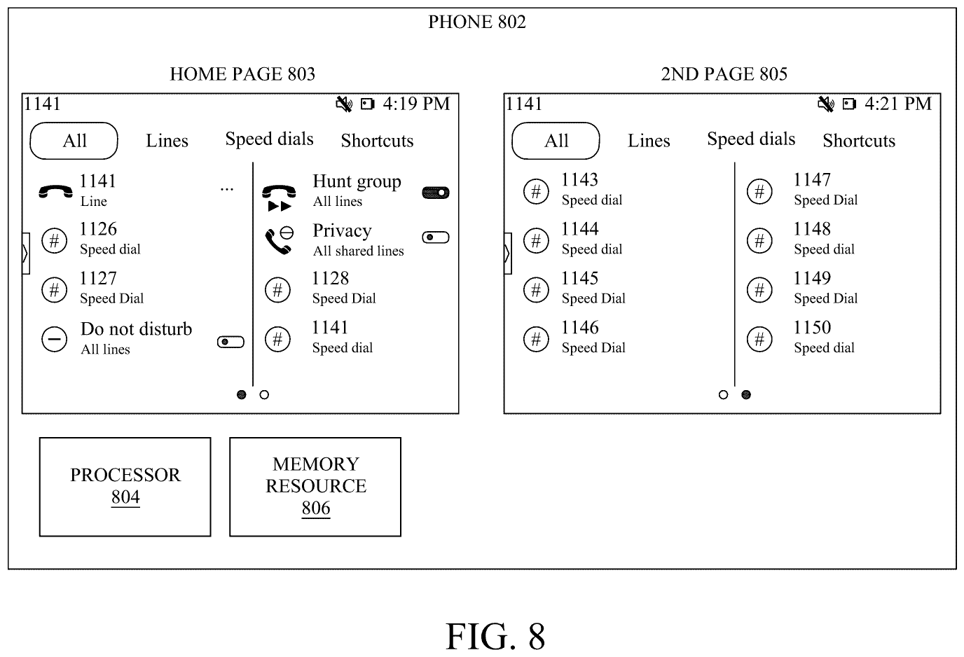

FIG. 8 illustrates an example of key pages associated with a phone when the phone is not paired to a key extension module (KEM). As shown in FIG. 8, a phone 802, which can be analogous to the phone 302 (and subsequent references to the phone herein) includes a processor 804 and a memory resource 806, respectively, which can be analogous to the processor 304 and the memory resource 306 illustrated in FIG. 3, herein. The phone 802 is shown as including a home page 803 and a second page 805. The second page 805 can be analogous to one of the “hidden pages” described above (e.g., (e.g., a first hidden page 324-1, a second hidden page 324-2, through an N^{th} hidden page 324-N of FIG. 3), while the home page 803 can be analogous to the home page 320 of FIG. 3.

As shown in FIG. 8, the home page 803 shows eight keys and the second page 805 shows eight keys. However, the eight keys shown on the second page 805 are “hidden” and therefore require user interaction to access. As discussed above, this approach can be inconvenient for a user who wishes to access the keys shown on the hidden page(s), such as the second page 805.

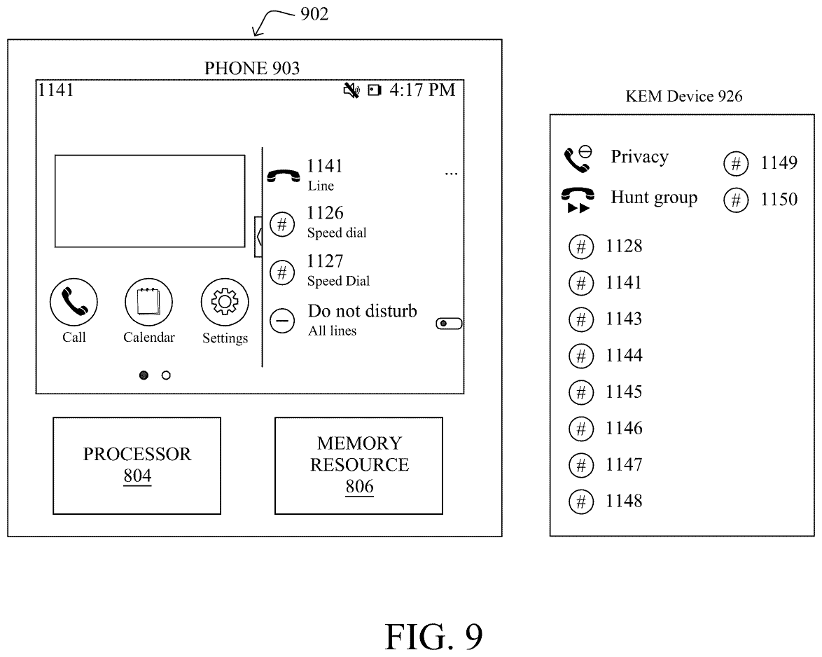

FIG. 9 illustrates an example of a phone paired to a key extension module where the key extension module where a specified number of keys are automatically moved to the key extension module in response to pairing the key extension module to the phone. As shown in FIG. 9, a phone 902, which can be analogous to the phone 302 (and subsequent references to the phone herein) includes a processor 904 and a memory resource 906, respectively, which can be analogous to the processor 304 and the memory resource 306 illustrated in FIG. 3, herein.

In contrast to the example of FIG. 8, a specified number of keys are automatically moved to the KEM 926 when the KEM 926 is paired to the phone 902. In the specific example shown in FIG. 9, The specified key count on the phone 902 is four (e.g., four line keys and/or function keys are displayed on the home screen of the phone). Accordingly, only four keys are shown on the phone 902 (e.g., the home screen 903) while other keys (e.g., eight line keys and/or function keys) are shown on the KEM 926. In this implementation, all sixteen keys (four keys on the home screen of the phone and twelve keys on the KEM) are visible and easy to access for the user.

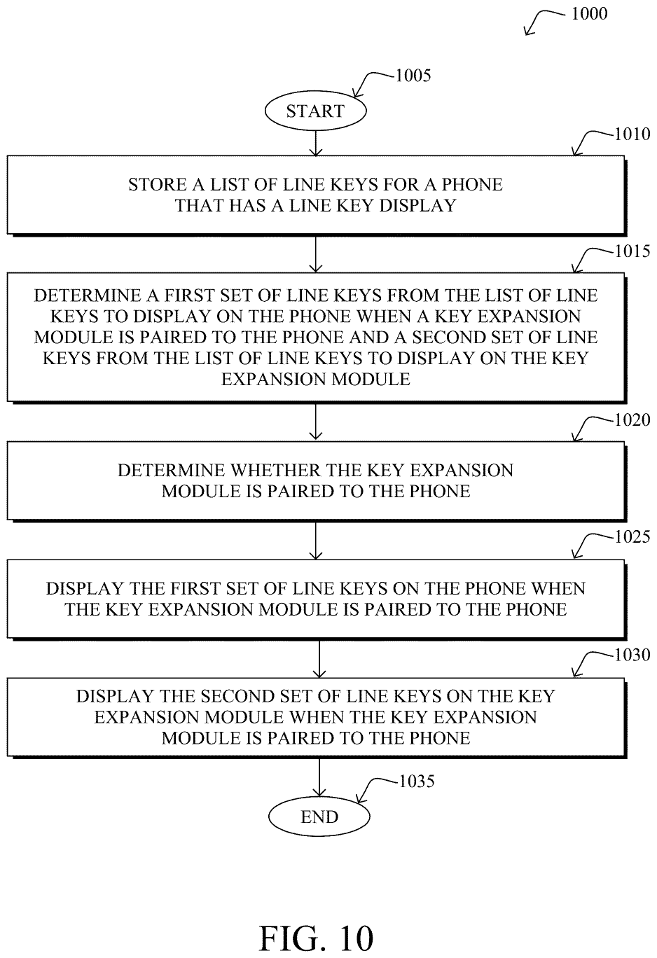

FIG. 10 illustrates an example procedure for adaptive line key allocation for key expansion modules in accordance with one or more embodiments described herein, particularly from the perspective of a device, such as a phone and/or a KEM. For example, a non-generic, specifically configured device (e.g., device 200, an apparatus) may perform procedure 1000 by executing stored instructions (e.g., process 248). The procedure 1000 may start at step 1005, and continues to step 1010, where, as described in greater detail above, a list of line keys for a phone that has a line key display is stored. The list of line keys may be stored in a memory resource, such as the memory resource 906 described above. In some implementations, the phone can include a fixed soft key configuration associated with physical keys on phone and/or the phone can include a dynamic soft key configuration displayed on a touch screen associated with the phone.

The procedure 1000 may continue to step 1015, where, as described in greater detail above, a first set of line keys from the list of line keys to display on the phone when a key expansion module is paired to the phone and a second set of line keys from the list of line keys to display on the key expansion module are determined. In some implementations, the first set of line keys can be spread out on multiple display pages of the phone.

The procedure 1000 may continue to step 1020, where, as described in greater detail above, a determination is made as to whether the key expansion module is paired to the phone. In some implementations, the key expansion module being paired to the phone can include the key expansion module being physically coupled to the phone via a wired connection or the key expansion module being communicatively coupled to the phone via a wireless connection, although implementations are not so limited.

The procedure 1000 may continue to step 1025, where, as described in greater detail above, the first set of line keys are displayed on the phone when the key expansion module is paired to the phone. In some implementations, the first set of line keys comprise a customizable prioritized set of line keys from the list of line keys that are displayed on the phone.

The procedure 1000 may continue to step 1030, where, as described in greater detail above, the second set of line keys are displayed on the key expansion module when the key expansion module is paired to the phone. In some implementations, the procedure 1000 can include selecting the first set of line keys and the second set of line keys when the key expansion module is paired to the phone based on one or more configuration settings. Further, as described above, the procedure 1000 can include altering a display format of line keys on phone in response to the key expansion module being paired to the phone.

The procedure 1000 can further include determining that the key expansion module is not paired to the phone and displaying the first set of line keys and the second set of line keys on the phone in response to the determination that the key expansion module is not paired to the phone.

In some implementations, the key expansion module is configured to automatically operate as an extension of a home screen of the phone to concurrently provide full visibility to the first set of line keys displayed on the phone and the second set of line keys displayed on the key expansion module, as described above.

In some implementations, the procedure 1000 can include providing a plurality of feature keys and program keys to at least one of the phone, the key expansion module, or a combination thereof.

In some implementations, the procedure 1000 can include splitting the first set of line keys into a plurality of subsets of line keys; displaying subsets among the plurality of subsets of line keys across more than one scrollable page associated with the phone; and displaying at least one subset among the plurality of subsets of line keys on the key expansion module.

Procedure 1000 may end at step 1035.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: a telecommunication device that has a line key display, a processor operatively coupled to the telecommunication device (e.g., a phone), and a memory resource operatively coupled to the processor. In such implementations, the processor can be configured to execute instructions to: store, in the memory resource, a list of line keys for visualization on the line key display; determine a first set of line keys from the list of line keys to display on the telecommunication device when a key expansion module is coupled to the telecommunication device and a second set of line keys from the list of line keys to display on the key expansion module when the key expansion module is coupled to the telecommunication device; determine whether the key expansion module is coupled to the telecommunication device; cause the first set of line keys to be displayed on the telecommunication device when the key expansion module is coupled to the telecommunication device; and cause the second set of line keys to be displayed on the key expansion module when the key expansion module is coupled to the telecommunication device.

In still other implementations, a tangible, non-transitory, computer-readable medium storing program instructions that cause a device to execute a process comprising: storing a list of line keys for a phone that has a line key display; determining a first set of line keys from the list of line keys to display on the phone when a key expansion module is paired to the phone and a second set of line keys from the list of line keys to display on the key expansion module; determining whether the key expansion module is paired to the phone; displaying the first set of line keys on the phone when the key expansion module is paired to the phone; and displaying the second set of line keys on the key expansion module when the key expansion module is paired to the phone.

The techniques described herein, therefore, provide for adaptive line key allocation for key expansion modules designed to enhance the visibility and accessibility of line keys and/or feature keys across both a phone screen and KEMs paired to the phone. In contrast to approaches described above that lead to inconveniences associated with accessing line keys and/or function keys on hidden pages of a phone, as well as wasted resources, time-intensive processes, and frustration to both users and administrators of systems that employ phones and/or KEMs, the techniques described herein provide for automatic and intuitive solutions to the shortcomings of previous approaches, thereby yielding a more holistic, user friendly experience to using KEM(s) and other expansion modules with telecommunication devices.

For example, the techniques herein provide (among other benefits):
High usability—The user can always have all the line keys and feature keys with or without key expansion modules.
Enhanced visibility—With key expansion modules attached to a phone, all the states of the line keys and feature keys are visible.
Convenience—With key expansion modules attached to a phone, all the line keys and feature keys are easy to access.
Easy key layout management—The keys can be shown either on the phone screen or a key expansion module.

Illustratively, the techniques described herein may be performed by hardware, software, and/or firmware, (e.g., an “apparatus”) such as in accordance with the line key allocation process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
storing, by a process, a list of line keys for a phone that has a line key display;
determining, by the process, a first set of line keys from the list of line keys to display on the phone when a key expansion module is paired to the phone and a second set of line keys from the list of line keys to display on the key expansion module;
determining whether the key expansion module is paired to the phone;
displaying the first set of line keys on the phone when the key expansion module is paired to the phone; and
displaying the second set of line keys on the key expansion module when the key expansion module is paired to the phone.

2. The method of claim 1, further comprising:
determining, by the process, that the key expansion module is not paired to the phone; and
displaying, by the process, the first set of line keys and the second set of line keys on the phone.

3. The method of claim 1, further comprising:
spreading the first set of line keys out on multiple display pages of the phone.

4. The method of claim 1, further comprising:
providing a plurality of feature keys and program keys to at least one of the phone, the key expansion module, or a combination thereof.

5. The method of claim 1, wherein the key expansion module is configured to automatically operate as an extension of a home screen of the phone to concurrently provide full visibility to the first set of line keys displayed on the phone and the second set of line keys displayed on the key expansion module.

6. The method of claim 1, wherein the first set of line keys comprise a customizable prioritized set of line keys from the list of line keys that are displayed on the phone.

7. The method of claim 1, further comprising:
selecting, by the process, the first set of line keys and the second set of line keys when the key expansion module is paired to the phone based on one or more configuration settings.

8. The method of claim 1, further comprising:
splitting, by the process, the first set of line keys into a plurality of subsets of line keys;
displaying subsets among the plurality of subsets of line keys across more than one scrollable page associated with the phone; and
displaying at least one subset among the plurality of subsets of line keys on the key expansion module.

9. The method of claim 1, further comprising:
altering, by the process, a display format of line keys on phone in response to the key expansion module being paired to the phone.

10. The method of claim 1, wherein the key expansion module being paired to the phone comprises the key expansion module being physically coupled to the phone via a wired connection or the key expansion module being communicatively coupled to the phone via a wireless connection.

11. The method of claim 1, wherein:
the phone includes a fixed soft key configuration associated with physical keys on phone, or
a dynamic soft key configuration displayed on a touch screen associated with the phone.

12. An apparatus, comprising:
a telecommunication device that has a line key display;
a processor operatively coupled to the telecommunication device; and
a memory resource operatively coupled to the processor, wherein the processor is configured to execute instructions to:
store, in the memory resource, a list of line keys for visualization on the line key display;
determine a first set of line keys from the list of line keys to display on the telecommunication device when a key expansion module is coupled to the telecommunication device and a second set of line keys from the list of line keys to display on the key expansion module when the key expansion module is coupled to the telecommunication device;
determine whether the key expansion module is coupled to the telecommunication device;
cause the first set of line keys to be displayed on the telecommunication device when the key expansion module is coupled to the telecommunication device; and
cause the second set of line keys to be displayed on the key expansion module when the key expansion module is coupled to the telecommunication device.

13. The apparatus of claim 12, wherein the processor is configured to execute instructions to:
determine that the key expansion module is not paired to the telecommunication device; and
display the first set of line keys and the second set of line keys on the telecommunication device.

14. The apparatus of claim 12, wherein the key expansion module is configured to automatically operate as an extension of a home screen of the telecommunication device to concurrently provide full visibility to the first set of line keys displayed on the telecommunication device and the second set of line keys displayed on the key expansion module.

15. The apparatus of claim 12, wherein the first set of line keys comprise a customizable prioritized set of line keys from the list of line keys that are displayed on the telecommunication device.

16. The apparatus of claim 12, wherein the processor is configured to execute instructions to:
split the first set of line keys into a plurality of subsets of line keys;
display subsets among the plurality of subsets of line keys across more than one scrollable page associated with the telecommunication device; and
display least one subset among the plurality of subsets of line keys on the key expansion module.

17. The apparatus of claim 12, wherein the processor is configured to execute instructions to:
alter a display format of line keys on phone in response to the key expansion module being paired to the telecommunication device.

18. The apparatus of claim 12, wherein the first set of line keys comprise a customizable prioritized set of line keys from the list of line keys that are displayed on the telecommunication device.

19. The apparatus of claim 12, wherein the processor is configured to execute instructions to:
select the first set of line keys and the second set of line keys when the key expansion module is paired to the telecommunication device based on one or more configuration settings.

20. A tangible, non-transitory, computer-readable medium storing program instructions that cause a device to execute a process comprising:
storing a list of line keys for a phone that has a line key display;
determining a first set of line keys from the list of line keys to display on the phone when a key expansion module is paired to the phone and a second set of line keys from the list of line keys to display on the key expansion module;
determining whether the key expansion module is paired to the phone;
displaying the first set of line keys on the phone when the key expansion module is paired to the phone; and
displaying the second set of line keys on the key expansion module when the key expansion module is paired to the phone.
